(19) United States
(12) Patent Application Publication
(10) Pub. No.: US 2022/0329144 A1
(43) Pub. Date: Oct. 13, 2022

(54) Self-Contained Electric Energy Generator System

(71) Applicants: Ransey Harvey, Johnson City, TN (US); Christopher Burke, Bluff City, TN (US)

(72) Inventors: Ransey Harvey, Johnson City, TN (US); Christopher Burke, Bluff City, TN (US)

(21) Appl. No.: 17/409,754

(22) Filed: Aug. 23, 2021

Related U.S. Application Data
(60) Provisional application No. 63/171,737, filed on Apr. 7, 2021.

(51) Int. Cl. H02K 51/00; H02K 7/02; H02K 7/10; H02K 9/06

(52) U.S. Cl. CPC H02K 51/00; H02K 7/02; H02K 7/1004; H02K 9/06

(57) ABSTRACT

The present invention relates to a self-contained and powered electric energy generator system. The energy generator system comprises a pair of generators designed to provide power to an external item, and wherein one of the generators is also configured to provide input power to an integrated AC motor. The AC motor is connected to a flywheel, which stores kinetic energy from the rotation of the AC motor. Then, the generators produce electricity by converting the stored kinetic energy into electrical energy. The generator system does not need fuel or external sources for generating electricity, and accordingly is cost efficient and environmentally friendly.

### CROSS-REFERENCE TO RELATED APPLICATION

The present application claims priority to, and the benefit of, U.S. Provisional Application No. 63/171,737, which was filed on Apr. 7, 2021 and is incorporated herein by reference in its entirety.

### FIELD OF THE INVENTION

The present invention relates generally to electric generators. More specifically, the present invention relates to a self-contained and powered electric generator system for generating cost-efficient and environmentally friendly electricity. The self-powered electric generator system is portable and can be used in remote areas. The system comprises two generators, one AC motor, one flywheel, one generator frame, two pillow block bearings, one steel shaft, a plurality of scrap steel pieces for modifying the generators, four pulleys and a fan for cooling the motor and generators. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, generators are used for producing electricity, typically during power outages. Generally, users may have to wait for a generator to turn on for electricity to be produced. A diesel generator is the combination of a diesel engine with an electric generator for generating electrical energy. The diesel engine continues to be a significant source of mechanical power generation for both mobile and stationary applications. However, the diesel generator is typically designed to run on gasoline or requires the burning of fuel, which creates pollution and greenhouse gases. Further, diesel engines are associated with high levels of pollutants such as nitrogen oxides, particulate matters, toxicity and high levels of nano-particles, etc. Also, the cost of the fuel for diesel generators, as well as the cost of transportation for fuel from remote and hostile locations, also makes them inefficient for use.

Conventional electric generators installed in households and businesses provide power during a power outage. These generators work as a backup for providing electricity to homes and/or businesses. However, these electric generators are expensive and difficult to handle due to their large size. Further, businesses such as hospitals rely on an electric grid for electricity. However, when power outages occur for these businesses, it is not only inconvenient, but also dangerous for users to have to wait for their power to come back on.

Additionally, solar generators are used to convert energy from sunlight into electricity, either directly using photovoltaics, or indirectly using concentrated solar power or a combination of both. Concentrated solar power systems use lenses or mirrors and solar tracking systems to focus a large area of sunlight into a small beam. Photovoltaic cells convert the light into an electric current using the photovoltaic effect. Solar generators are a great source of backup power for a boat or RV (recreational vehicle) because of their portability. However, solar generators rely on sunlight which is available only during daylight hours and, therefore, cannot provide power when power outages occur at night.

Therefore, there exists a long felt need in the art for an electric generator system that produces power without using fuel, such as a gasoline or diesel engine, or any type of wind, solar or waterpower. There exists a long felt need in the art for an electric generator system that not only powers itself, but provides electricity to a wide variety of items that are plugged into it. Additionally, there is a long felt need in the art for an electric generator system that eliminates the production of pollutants, harmful gases and/or greenhouse gases. Moreover, there is a long felt need in the art for an electric generator system that eliminates the need for expensive fuel and other energy sources. Moreover, there is a long felt need in the art for an electric generator system that offers a highly portable unit that produces electricity at home, camping, on construction sites, hospitals, schools, etc. Finally, there is a long felt need in the art for an electric generator system that is environmentally-friendly and can power itself, along with providing electrical energy to a plurality of items.

The subject matter disclosed and claimed herein, in one embodiment thereof, comprises a green energy generator that not only powers itself, but a plurality of items that are plugged into it for power. The energy generator comprises two generator units and a flywheel that work together to produce electricity. The energy generator further comprises one AC motor, one generator frame, two pillow block bearings, one steel shaft and one thick spring for the tensioner. The energy generator further includes a plurality of scrap steel pieces for modifying the generators. The energy generator further comprises four pulleys and a fan for cooling the motor and generators.

In this manner, the novel electric generator system of the present invention accomplishes all of the forgoing objectives, and not only powers itself, but also a wide variety of items that are plugged into it for power. The electric generator system of the present invention is built using two generator units and a flywheel, that work together to produce electricity and eliminate the need to produce power using fuel, such as a gasoline or diesel engine, or any type of wind, solar or waterpower. The electric generator system of the present invention is also environmentally friendly, and does not create pollution or emit greenhouse gases. The electric generator system is cost effective for users. Additionally, the energy generator powers itself and a plurality of items that are plugged into the unit.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-powered electric generator system. The self-powered electric generator system is designed to produce electrical power without using fuel or other types of energy such as wind, solar, water, etc. More specifically, the generator system comprises two independent generators, an AC motor, a flywheel, a steel shaft and a pulley connected to each of the generators, the AC motor, and the steel shaft, wherein said independent generators, said AC motor, said flywheel and said steel shaft are housed within a generator frame. Further, each generator comprises a pillow block bearing and a fan for cooling the motor and generators. Each generator comprises a 110V and 220V output. The AC motor comprises a 110V input supply, and the 110V output of one of the generators is connected to the 110V input supply of the AC motor. The flywheel stores kinetic energy from the rotation of the AC motor, and the generators generate electricity from the stored kinetic energy of the flywheel.

In a further embodiment of the present invention, a free energy generator is disclosed. The free energy generator includes an AC motor connected to a flywheel, such that kinetic energy from the AC motor is stored in the flywheel. The free energy generator also includes a first generator and a second generator, wherein each generator converts the stored energy from the flywheel into electricity. Further, both the first generator and the second generator comprise 110V and 220V output power ports, wherein the 110V output power port of the second generator is connected to a 110V input power supply of the AC motor. Thus, this creates a self-powered infinite feedback loop for powering the AC motor and generating electricity without any fuel. The self-powered electric generator eliminates pollution and greenhouse gases, as well as the high costs of fuel and other energy sources. The generator system powers itself and a plurality of items that are plugged into the unit.

In yet another embodiment of the present invention, a method for generating electricity without using any fuel is described. The method includes initially rotating an AC motor, storing the kinetic energy from the AC motor using a flywheel, converting the stored kinetic energy into electrical energy using a pair of generators, feeding the generated electricity from one of the generators to the AC motor to allow the AC motor to continuously rotate and store the kinetic energy and producing electricity. The electricity produced is used for providing power to the connected electrical appliances in case of power outages.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed, and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the self-powered electric energy generator system of the present invention in accordance with the disclosed architecture;

FIG. 2 illustrates a perspective view of one potential embodiment of the self-powered electric energy generator system of the present invention, wherein the system can supply electrical power to a plurality of items in accordance with the disclosed architecture;

FIG. 3 illustrates a block diagram showing one potential embodiment of the power connections and flow of the self-powered electric energy generator of the present invention in accordance with the disclosed architecture;

FIG. 4 illustrates a perspective view showing one potential embodiment of the separate components of the self-powered electric energy generator of the present invention in accordance with the disclosed architecture; and

FIG. 5 illustrates a perspective view of one potential embodiment of the generator unit of the self-powered electric energy generator system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long felt need in the art for an electric generator system that produces power without using fuel, such as a gasoline or diesel engine, or any type of wind, solar, waterpower, etc. There exists a long felt need in the art for an electric generator system that not only powers itself, but provides electricity to a plurality of items. Additionally, there is a long felt need in the art for an electric generator system that eliminates the production of pollutants, harmful gases and/or greenhouse gases. Moreover, there is a long felt need in the art for an electric generator system that eliminates the need for high cost fuels and other energy sources. Moreover, there is a long felt need in the art for an electric generator system that provides a portable unit that can produce electricity for homes, camps, construction sites, hospitals, schools, etc. Finally, there is a long felt need in the art for an electric generator system that is environmentally-friendly and can power itself along, thereby providing electrical energy to a plurality of items that are plugged into the system.

The present invention, in one exemplary embodiment, is a novel free energy generator. The free energy generator comprises an AC motor connected to a flywheel, wherein kinetic energy from the AC motor is stored in the flywheel. Further, the free energy generator comprises a first generator and a second generator, wherein each generator coverts stored energy from the flywheel into electricity. Additionally, both the first generator and the second generator comprise 110V and 220V output power ports, wherein the 110V output power port of the second generator is connected to a 110V input power supply of the AC motor, creating a self-powered infinite feedback loop for powering the AC motor and generating electricity without any fuel.

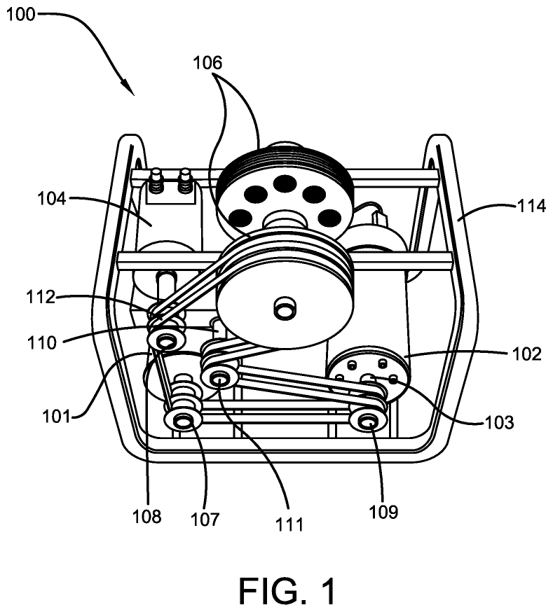

Referring initially to the drawings, FIG. 1 illustrates a perspective view of one embodiment of the self-powered electric energy generator system of the present invention. The self-powered electric energy generator system 100 of the present invention is self-powered, and does not require fuel for generating electricity. The self-powered electric energy generator system 100 of the present invention can be used to produce electricity for homes, camps, construction sites, hospitals, schools, etc., and any other suitable place as is known in the art. More specifically, the electric energy generator 100 of the present invention is designed to recover energy from a flywheel, by using the energy recovery system to recover energy produced from the flywheel, which then produces sufficient energy to run a project set up and also to run an external power supply.

The electric energy generator 100 of the present invention comprises two generator units, a first generator 101 and a second generator 102. Both the first generator 101 and the second generator 102 convert mechanical energy into electrical energy, to provide power to a plurality of items that are plugged into the electric energy generator 100. The generator units 101, 102 use mechanical energy supplied to them via the force generated from the movement of electrical charges present in the wire of the generator units' 101, 102 windings through an external electric circuit. As known in the art, the windings are an essential part of the generators and are internally disposed within the generators 101, 102. Thus, the windings are not shown for simplicity.

The electric energy generator system 100 comprises an AC motor 104 that is used for driving one or more pulleys, and a belt arrangement 112 that forms a gear train arrangement for producing a high-speed rotation of the shaft 103 of the second generator unit 102. The electric energy generator system 100 comprises a flywheel 106 that is configured for storing kinetic energy in the form of inertia. The flywheel 106 is a mechanical device specially designed to efficiently store rotational energy. The flywheel 106 can be rotated at an operating speed using the AC motor 104 which results in the storage of kinetic energy in the flywheel 106. As the flywheel 106 spins faster, the flywheel 106 experiences a greater force and thus stores more energy. The inertia of the flywheel 106 can be increased by increasing the radius or weight of the flywheel 106. The flywheel 106 can be manufactured of steel, or other suitable materials known in the art, and can rotate on conventional bearings 105. In the preferred embodiment, the flywheel 106 is a solid disk flywheel or a rimmed flywheel, but can be any suitable flywheel known in the art. The flywheel 106 uses the AC motor 104 for driving rotation of the flywheel 106 at a high speed so that the produced kinetic energy is transformed into mechanical power (or energy). Then, the mechanical energy stored in the flywheel 106 is converted into electricity by the first generator 101 and the second generator 102.

The belt arrangement 112 moves continuously like a conveyer belt via the set of pulleys of the electric generator system 100 to form a gear train structure. More specifically, the first generator unit 101 comprises a first pulley 107, wherein the AC motor 104 comprises a second pulley 108, the second generator unit 102 comprises a third pulley 109 and the steel shaft 110 comprises a fourth pulley 111. The pulleys 107, 108, 109, 111, together with the belt arrangement 112, vary the speed of the steel shaft 110 of the electric energy generator 100. Further, all of the aforementioned components of the electric generator system 100 are secured together within a generator frame 114 using mechanical screws, or any other suitable screw as is known in the art. The generator frame 114 can be portable and can also comprise integrated casters which allow a user to operate and transport the electric generator system 100 more conveniently.

It is to be appreciated that by using the flywheel 106, the electric generator system 100 can generate electrical energy without using fuel, and thus this free energy generation is non-hazardous and environmentally friendly. The energy generated by the electric generator system 100 using the flywheel 106 can be used in various applications such as electric fuel cars, household items, industrial items, etc., and can even increase the efficiency of traditional electrical energy.

In operation, the AC motor 104 comprises a 110V input cord for receiving input electrical energy from the 110V output of the second generator 102. Specifically, when the AC motor 104 runs, kinetic energy from the AC motor 104 is stored using the flywheel 106. The stored kinetic energy in the flywheel 106 is then used for generating electricity by both the first generator 101 and the second generator 102. Further, each generator unit 101, 102 comprises a 110 V and 220V outlet, wherein the output from the 110V of the second generator 102 is fed back to the AC motor 104 through the 110V input cord (or port) of the AC motor 104, and then the 220V outlet of the generators 101, 102 is used for providing power to associated devices. It should be appreciated that since the 110V output of the second generator 102 is fed to the AC motor 104, the electric energy generation system 100 is a self-powered system without fuel requirements.

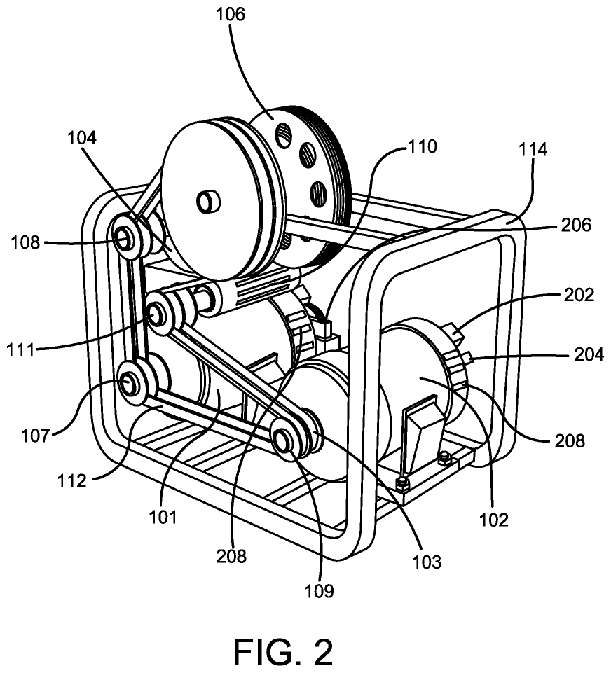

FIG. 2 illustrates a perspective view of one embodiment of the self-powered electric energy generator system. As stated earlier, the electric energy generator 100 can not only power itself using the 110V output 202 of the second generator 102 which is fed back into the AC motor 104, but also powers a plurality of items that are plugged into the electric generator system 100 using the 220V output port 204 of the second generator 102, and both the 110V and 220V output supply 206 of the first generator 101. The AC motor 104 uses the electrical power received from the second generator 102 and starts converting the received electrical energy into kinetic energy, which is used for rotating the flywheel 106. The flywheel 106, the first generator 101, the second generator 102 and the AC motor 104 work synchronously together using the first pulley 107 of the first generator unit 101, the second pulley 108 of the AC motor 104, the third pulley 109 of the second generator unit 102 and the fourth pulley 111 of the steel shaft 110 through a belt arrangement 112. The movement of the flywheel 106 powers rotating electromagnets which are disposed within the generator units 101, 102 for generating electric power. The electric generator system 100 also comprises a fan 208 for cooling the AC motor 104 and the generators 101 and 102.

The electric energy generator system 100 recovers energy produced by the flywheel 106 by using the principle of energy recovery from the flywheel 106 and producing sufficient energy to run the project set up, and also additional energy to run an external power supply along with supplying power to the AC motor 104. The flywheel 106 can be rotated at its operating speed using the AC motor 104, which results in storage of kinetic energy. Specifically, as the flywheel 106 spins faster, it experiences greater force and thus stores more energy. The flywheel 106 stores the energy using its moment of inertia based on the following formula:

E=½Iω2

Where ‘E’ is the energy
‘I’ is the moment of inertia
‘ω’ is the angular velocity
The moment of inertia can be calculated by
I=½m (r external2+r internal 2)

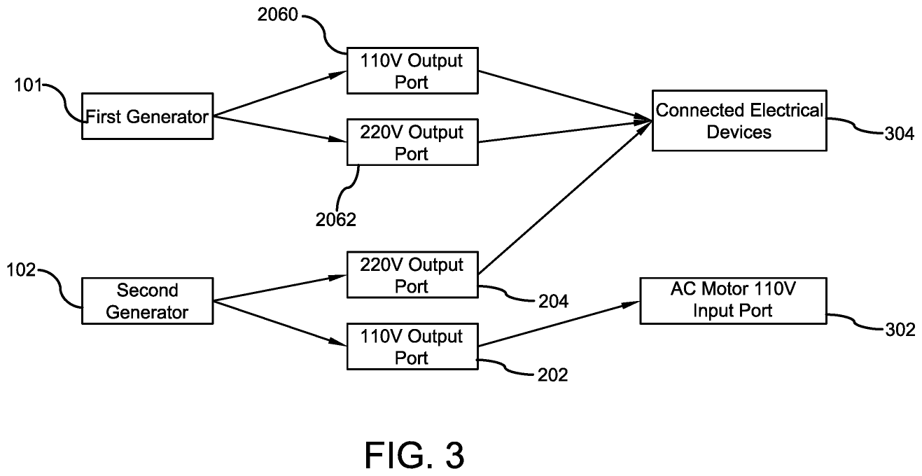

FIG. 3 illustrates a block diagram showing power connections and flow of the electric energy generator. As shown, the first generator 101 comprises a 110V output port 2060 and a 220V output port 2062 (collectively shown as 206 in FIG. 2). The second generator 102 also comprises a 110V output port 202 and a 220V output port 204. The 110V output port 2060, the 220V output port 2062 of the first generator 101 and the 220V output port 204 of the second generator 102 provide power to connected electrical devices 304, which are connected to the electric energy generator system 100. The 110V output port 202 of the second generator 102 is fed to the 110V input port 302 of the AC motor, therefore allowing the electric generator system 100 to be self-dependent. Further, the second generator 102, to which the AC motor is plugged into, produces more electricity than is required for the motor to run, thus allowing the generators to provide power to the connected electrical devices 304.

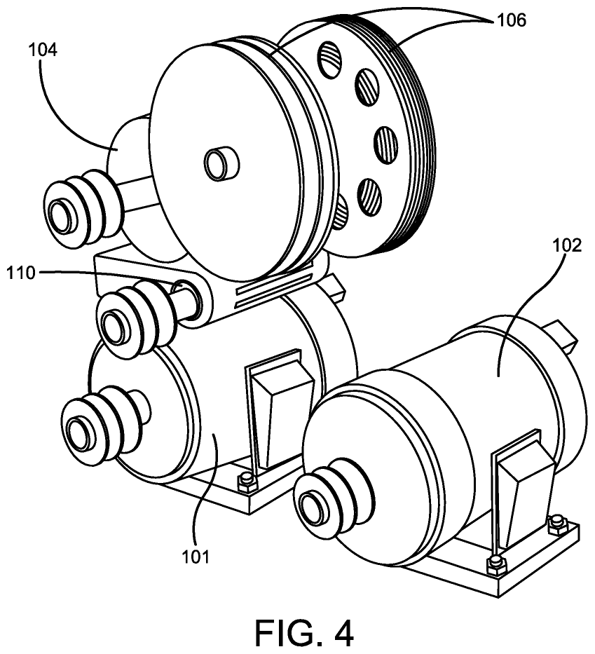

FIG. 4 illustrates a perspective view showing separate components of the electric energy generator of the present invention. As shown in FIG. 4, the electric energy generator 100 comprises two generator units: a first generator unit 101 and a second generator unit 102. In the preferred embodiment, the second generator unit 102 is removably secured to the AC motor 104, thus if the AC motor 104 needs to be fed with an external power supply, the second generator unit 102 can be detached. The first generator unit 101, the steel shaft 110 and the AC motor 104 are securely connected to each other along with the flywheel 106. The AC motor 104 used in the present invention is similar to a conventional AC motor 104, and consists of two basic parts, an outside stator having coils supplied with alternating current to produce a rotating magnetic field, and an inside rotor attached to the output shaft producing a second rotating magnetic field. The AC motor 104 starts by utilizing the electricity from the 110V output port of the second generator unit 102.

The AC motor 104 rotates the flywheel 106 at its operating speed, which results in storage of kinetic energy. The flywheel 106 is a mechanical device specially designed to efficiently store rotational energy. As the flywheel 106 spins faster, it experiences greater force and thus stores more energy. The inertia of the flywheel 106 can be increased by increasing the radius of the flywheel, or the weight of the flywheel. The flywheel 106 energy storage uses electric motors to drive the flywheel 106 to rotate at a high speed, such that the electrical power is transformed into mechanical power and stored, and when necessary, the flywheel 106 drives the generators 101, 102 to generate electrical power. Additionally, in generators 101, 102, a plurality of scrap steel pieces can be used for allowing the generators to have 110V and 220V ports. Thus, the plurality of scrap steel pieces are integrated into the generators 101, 102.

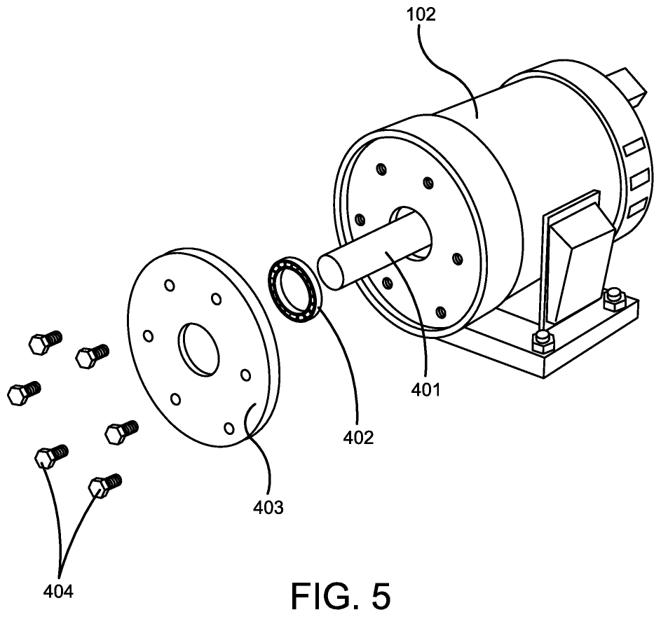

FIG. 5 illustrates a perspective view of a generator unit used in the electric generator system of the present invention along with its components. The second generator unit 102, by means of the flywheel, generates electric power and conveys this electric power to a plurality of items that are plugged into the generator unit 102 for power. The generator unit 102 comprises a steel shaft 401. The steel shaft 401 can be made of alloy steel, or any other suitable type of material as is known in the art. The generator unit 102 also comprises pillow block bearings 402 to support each end of the steel shaft 401. The bearings 402 do not conduct electricity, but instead resist the damage caused by electricity. The bearings 402 can support each end of the steel shaft 401 by means of the steel plate 403, and one or more modified steel screws 404 or other suitable securing means as is known in the art. It should be noted that the second generator unit 102 and the first generator unit 101, typically have the same architecture and components for generating electricity using the flywheel.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-powered electric energy generator system”, “electric generator system”, “green energy generator”, “electric energy generator system” and “energy generator” are interchangeable and refer to the self-powered electric energy generator system 100 of the present invention.

Notwithstanding the forgoing, the self-powered electric energy generator system 100 of the present invention can be of any suitable size and configuration as is known in the art without affecting the overall concept of the invention, provided that it accomplishes the above stated objectives. One of ordinary skill in the art will appreciate that the size, configuration, and material of the self-powered electric energy generator system 100 as shown in FIGS. 1-5 is for illustrative purposes only, and that many other sizes and shapes of the self-powered electric energy generator system 100 are well within the scope of the present disclosure. Although the dimensions of the self-powered electric energy generator system 100 are important design parameters for user convenience, the self-powered electric energy generator system 100 may be of any size that ensures optimal performance during use, and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-powered electric energy generator system that does not require fuel for generating electricity, the self-powered electric energy generator system comprising:
a first generator;
a second generator comprising a shaft;
a flywheel;
at least one pulley;
a belt arrangement; and
an AC motor used for driving the at least one pulley and the belt arrangement which form a gear train arrangement for producing a high-speed rotation of the shaft of the second generator, wherein the flywheel is configured for storing a kinetic energy and further wherein the kinetic energy stored in the flywheel is converted into electricity by the first generator and the second generator.

2. The self-powered electric energy generator system of claim 1, wherein the flywheel is rotated at an operating speed using the AC motor which results in storage of kinetic energy in the flywheel.

3. The self-powered electric energy generator system of claim 2, wherein as the flywheel spins faster, the flywheel stores more energy.

4. The self-powered electric energy generator system of claim 3, wherein increasing a radius or weight of the flywheel increases an inertia of the flywheel.

5. The self-powered electric energy generator system of claim 4, wherein the flywheel is manufactured of steel and rotates on conventional bearings.

6. The self-powered electric energy generator system of claim 5, wherein the flywheel is a solid disk flywheel or a rimmed flywheel.

7. The self-powered electric energy generator system of claim 6, wherein the belt arrangement moves continuously like a conveyer belt via a set of pulleys.

8. The self-powered electric energy generator system of claim 7, wherein the first generator comprises a first pulley, the AC motor comprises a second pulley, the second generator comprises a third pulley, and the shaft comprises a fourth pulley.

9. The self-powered electric energy generator system of claim 8, wherein the first pulley, the second pulley, the third pulley, and the fourth pulley along with the belt arrangement varies speed of the shaft.

10. The self-powered electric energy generator system of claim 9, wherein the first generator, the second generator, the flywheel, the at least one pulley, the belt arrangement, and the AC motor are secured together within a generator frame.

11. The self-powered electric energy generator system of claim 10, wherein the generator frame comprises integrated casters for portability.

12. A self-powered electric energy generator system that does not require a fossil fuel for generating an electricity, the self-powered electric energy generator system comprising:
a first generator comprising a steel shaft and pillow block bearings which support each end of the steel shaft via a steel plate and at least one steel screw;
a second generator comprising a steel shaft and pillow block bearings which support each end of the steel shaft via a steel plate and at least one steel screw;
a flywheel;
at least one pulley;
a belt arrangement; and
an AC motor comprising a 110V input cord for receiving input electrical energy from the second generator, wherein the flywheel is configured for storing kinetic energy and further wherein the kinetic energy stored in the flywheel is converted into electricity by the first generator and the second generator.

13. The self-powered electric energy generator system of claim 12, wherein the first generator and the second generator comprise a 110 V and a 220 V outlet.

14. The self-powered electric energy generator system of claim 13, wherein output from the 110 V of the second generator is fed back to the AC motor through the 110 V input cord, then the 220V outlet of the first generator and the second generator is used for providing power to connected electrical devices.

15. The self-powered electric energy generator system of claim 14 further comprising a fan for cooling the AC motor, the first generator and the second generator.

16. The self-powered electric energy generator system of claim 15, wherein the AC motor uses electrical power received from the second generator and starts converting the electrical energy into kinetic energy which is used for rotating the flywheel.

17. The self-powered electric energy generator system of claim 16 wherein movement of the flywheel powers rotating electromagnets disposed within the first generator and the second generator for generating electric power, and further wherein the second generator is removably secured to the AC motor.

18. The self-powered electric energy generator system of claim 17, wherein the second generator is detached from the AC motor and the AC motor is fed with an external power supply.

19. A method for generating an electricity without using a fossil fuel, the method comprising the steps of:
initially rotating an AC motor;
storing kinetic energy from the AC motor using a flywheel;
converting the stored kinetic energy into electrical energy using a pair of generators;
feeding the generated electricity from one of the generators to the AC motor to allow the AC motor to continuously rotate; and
storing the kinetic energy and producing electricity.
